(19) United States
(12) Patent Application Publication
(10) Pub. No.: US 2026/0337422 A1
(43) Pub. Date: Oct. 29, 2026

(54) ELECTRODEPOSITION COATING MATERIAL COMPOSITIONS COMPRISING COMPOSITE PARTICLES CONTAINING METAL-CONTAINING CATALYST

(71) Applicant: BASF COATINGS GMBH, Muenster (DE)

(72) Inventors: Friederike MITTAG, Muenster (DE); Thorsten GELBRICH, Muenster (DE); Margarete ROHLMANN, Muenster (DE); Antoine Maxime Charles Joseph BEZIAU, Ludwigshafen (DE); Pierre-Eric MILLARD, Ludwigshafen (DE)

(21) Appl. No.: 19/104,774

(22) PCT Filed: Aug. 17, 2023
(86) PCT No.: PCT/EP23/72659

§ 371 Date: Feb. 19, 2025

(30) Foreign Application Priority Data
Sep. 15, 2022 (EP) 22195799.6

(51) Int. Cl. C09D 5/44; C08F 212/08; C08F 220/14; C09D 7/65; C09D 175/04; C25D 9/02

(52) U.S. Cl. CPC C09D 5/4465; C08F 212/08; C08F 220/14; C09D 5/4476; C09D 7/65; C09D 175/04; C25D 9/02; C08F 2800/20

(57) ABSTRACT

Described herein is an aqueous cathodically depositable electrodeposition coating material composition including (I) at least one binder dispersion including at least one cathodically depositable polymer (a) and at least one crosslinking agent component (b); and
(II) at least one pigment paste containing at least one pigment and/or filler (c) and at least one polymer as grinding resin,
where the composition also includes at least one kind of composite particles
(p) including at least one metal-containing catalyst (pc) and at least one (meth)acrylate polymer (mp).

The present invention n relates to an aqueous cathodically depositable electrodeposition coating material composition comprising at least one binder dispersion (I) comprising at least one cathodically depositable polymer (a) and at least one crosslinking agent (b) as well as at least one pigment paste (II) comprising at least one pigment and/or filler (c), wherein the composition also comprises at least one kind of composite particles (p) comprising at least one metal-containing catalyst (pc) and at least one (meth)acrylate-based polymer (mp), wherein the polymer (mp) is preferably prepared in the presence of the metal-containing catalyst (pc). The present invention also relates to a method for at least partially coating an electrically conductive substrate by cathodic electrodeposition coating comprising at least steps (1) to (5) including the step (1) of immersing of the substrate at least partially into an electrodeposition coating bath, which comprises the inventive electrodeposition coating material composition. Moreover, the present invention relates to an electrically conductive substrate, which is at least partially coated with a baked inventive electrodeposition coating material composition and/or which is obtainable by the inventive method. Finally, the present invention relates to the use of the composite particles (p) for increasing the robustness of an electrodeposition coating bath against phosphate contamination.

### BACKGROUND OF THE INVENTION

In the automobile sector, the metallic components used for manufacture must customarily be protected against corrosion. The requirements in terms of the corrosion control to be achieved are very exacting, not least because the manufacturers often offer a guarantee against rust perforation over many years. Such corrosion control is customarily achieved through the coating of the components, or of the substrates used to manufacture them, with at least one coating suitable for that purpose.

In order to be able to ensure the necessary corrosion control, it is common practice to apply a phosphate pretreatment composition (for example a zinc phosphate-based composition) to the metallic substrate, before then an electrodeposition coating film is applied. Electrodeposition coating (electrocoat) materials are coating materials which comprise polymers as binders including crosslinkers, pigments and/or fillers, and, frequently, additives. In general, there are anodically and cathodically depositable electrocoat materials. Anodic electrodeposition coating compositions comprising inter alia metal effect pigments are, e.g., disclosed in WO 2006/117189 A1. However, cathodically depositable materials have the greatest importance in industrial coating and particularly in automotive finishing. In cathodic electrodeposition coating, the substrates to be coated are immersed into an electrocoating bath and connected as the cathode. The bath has an anode as the counter electrode. The particles of the electrocoating material are stabilized with a positive charge and deposit on the cathode to form a coating film. Following deposition, the coated substrate is removed from the electrocoating bath, rinsed with water and the coating film is baked, i.e., thermally cured. During curing, chemical reaction and thus crosslinking of binder polymers and crosslinking agents occur, as for example the crosslinking of hydroxyl and/or amino groups with isocyanates. For facilitating effective curing and crosslinking reaction, electrodeposition coating compositions normally contain a respective catalyst, in particular a metal-containing catalyst like tin- or bismuth-containing catalysts.

Cathodically depositable electrocoat materials are known in the prior art, for example in EP 1 041 125 A1, DE 197 03 869 A1 and in WO 91/09917 A2.

As already described, the major purpose of cathodically depositable electrocoat materials is corrosion protection of metallic substrates. An effective crosslinking and thus film formation is, quite obviously, one of the most crucial elements for gaining such corrosion protection. Accordingly, the presence of sufficient amounts and concentrations of curing catalysts is key.

However, one major challenge in this aspect is that during regular use of electrodeposition coating baths tanked with the respective electrodeposition coating material composition (i.e. during coating of electrically conductive substrates by cathodic electrodeposition coating) a successive introduction of (and poisoning with) phosphate species is virtually unavoidable. Reason, quite obviously, is the phosphatizing pretreatment taking place before immersing the respective substrates into the electrodeposition baths. The phosphate, in turn, leads to contamination of the catalyst, i.e. degradation processes of the catalyst to inactive species not having any remaining or at least significantly reduced catalytic activity.

### Problem

It has been therefore an object underlying the present invention to provide an electrodeposition coating material, which overcomes the technical drawbacks mentioned above, i.e. which possesses high robustness against phosphate contamination. More specifically, the electrodeposition coating material and respective electrodeposition coating baths tanked with the respective electrodeposition coating material composition should show a significantly increased resistance against phosphate contamination. Accordingly, electrodeposition coatings produced by means of these baths and compositions, respectively, should be appropriately curable (i.e. crosslinkable), even if significant amounts of phosphate (illustrating a recognizable phosphate contamination in industrial real-life scenarios) are present in the baths during production.

### Solution

This object has been solved by the subject-matter of the claims of the present application as well as by the preferred embodiments thereof disclosed in this specification, i.e. by the subject matter described herein.

A first subject-matter of the present invention is an aqueous cathodically depositable electrodeposition coating material composition comprising
(I) at least one aqueous binder dispersion comprising at least one cathodically depositable polymer (a) and at least one crosslinking agent component (b)
(II) at least one pigment paste containing at least one pigment and/or filler (c) and at least one polymer as grinding resin,
   wherein the composition also comprises at least one kind of composite particles (p) comprising at least one metal-containing catalyst (pc) and at least one (meth)acrylate-based polymer (mp).

The above aqueous cathodically depositable electrodeposition coating material composition also is named inventive electrodeposition coating material composition or just inventive composition.

A further subject-matter of the present invention is a method for at least partially coating an electrically conductive substrate by cathodic electrodeposition coating comprising at least steps (1) to (5), namely
(1) immersing of the electrically conductive substrate at least partially into an electrodeposition coating bath, which comprises the inventive electrodeposition coating material composition,
(2) connecting the substrate as cathode,
(3) depositing a coating film obtained from the electrodeposition coating material composition on the substrate using direct current,
(4) removing the coated substrate from the electrodeposition coating bath, and
(5) baking the coating film deposited on the substrate.

A further subject-matter of the present invention is an electrically conductive substrate, which is at least partially coated with a baked inventive electrodeposition coating material composition and/or which is obtainable by the inventive method.

It has been surprisingly found that the inventive electrodeposition coating material composition allows for production of electrocoated substrates maintaining the desired properties of these coatings and substrates, even if significant amounts of phosphate are present. Therefore, the goal of achieving outstanding phosphate contamination resistance by maintaining an excellent characteristics profile of electrodeposition coatings produced under conditions involving comparably high phosphate concentrations was reached.

### DETAILED DESCRIPTION OF THE INVENTION

The term “comprising” in the sense of the present invention, in connection for example with the electrodeposition coating material composition of the invention, includes, but does not only has the meaning of “consisting of”. Accordingly, for example with regard to the electrodeposition coating material composition of the invention, it is possible that the binder dispersion (I)—in addition to components (a), (b) and water—for one or more of the further components identified hereinafter and included optionally in the electrodeposition coating material composition of the invention to be included therein. All components may in each case be present in their preferred embodiments as identified below. “Consisting of” may also be called “Only comprising” or “Exclusively comprising”, i.e. “comprising” may be called a generic term which includes the specific term “consisting of”.

### Inventive Electrodeposition Coating Material Composition

The cathodically depositable aqueous electrodeposition coating material composition of the invention (also named hereinafter inventive electrodeposition coating material composition or inventive composition) comprises at least one binder dispersion (I) comprising at least one cathodically depositable polymer (a) (also named component (a)) and at least one crosslinking agents (b) (also named component (b)) as well as at least one pigment paste (II) comprising at least one pigment and/or filler. The inventive composition also comprises water. The terms “electrodeposition coating material composition” and “electrodeposition coating composition” used herein are interchangeable.

The cathodically depositable aqueous electrodeposition coating material composition of the invention is suitable for at least partially coating an electrically conductive substrate with an electrodeposition coating composition, meaning that it is suitable for an at least partial application to the substrate surface of an electrically conductive substrate and whose application leads to an electrodeposition coating film onto the surface of the substrate.

The cathodically depositable electrodeposition coating material composition of the invention is aqueous. The term “aqueous” in connection with the electrodeposition coating material composition of the invention is understood preferably for the purposes of the present invention to mean that water, as solvent and/or as diluent, is present as the main constituent of all solvents and/or diluents present in the electrodeposition coating material composition, preferably in an amount of at least 35 wt.-%, based on the total weight of the electrodeposition coating composition of the invention. Organic solvents may be present additionally in smaller proportions, preferably in an amount of <20 wt.-%.

The electrodeposition coating composition of the invention preferably includes a water fraction of at least 40 wt.-%, more preferably of at least 50 wt.-%, still more preferably of at least 60 wt.-%, yet more preferably of at least 65 wt.-%, in particular of at least 70 wt.-%, most preferably of at least 75 wt.-%, based in each case on the total weight of the electrodeposition coating composition.

The electrodeposition coating composition of the invention preferably includes a fraction of organic solvents that is <10 wt.-%, more preferably in a range of from 0 to <10 wt.-%, very preferably in a range of from 0 to <7.5 wt.-% or of from 0 to <5 wt.-% or of from 0 to 2 wt.-%, based in each case on the total weight of the electrodeposition coating composition. Examples of such organic solvents would include heterocyclic, aliphatic, or aromatic hydrocarbons, mono- or polyhydric alcohols, especially methanol and/or ethanol, ethers, esters, ketones, and amides, such as, for example, N-methylpyrrolidone, N-ethylpyrrolidone, dimethylformamide, toluene, xylene, butanol, ethylene glycol, propylene glycol and butyl glycol ethers and also their acetates, butyl diglycol, diethylene glycol dimethyl ether, cyclohexanone, methyl ethyl ketone, methyl isobutyl ketone, acetone, isophorone, or mixtures thereof. Prominent examples of such organic solvents are, for example, ethylene glycol ethers like butyl glycol or propylene glycol ethers like butoxy propanol or phenoxy propanol.

The solids content of the electrodeposition coating material composition of the invention is preferably in a range of from 5 to 35 wt.-%, more preferably of from 7.5 to 30 wt.-%, very preferably of from 10 to 27.5 wt.-%, more particularly of from 12.5 to 25 wt.-%, most preferably of from 15 to 22.5 wt.-% or of from 15 to 20 wt.-%, based in each case on the total weight of the electrodeposition coating composition. The solids content, in other words the nonvolatile fraction, is determined in accordance with the method described hereinafter.

The electrodeposition coating material composition of the invention preferably has a pH in the range of from 2.0 to 10.0, more preferably in the range of from 2.5 to 9.5 or in the range of from 2.5 to 9.0, very preferably in the range of from 3.0 to 8.5 or in the range of from 3.0 to 8.0, more particularly in the range of from 2.5 to 7.5 or in the range of from 3.5 to 7.0, especially preferably in the range of from 4.0 to 6.5, most preferably in the range of from 3.5 to 6.5 or of from 5.0 to 6.0.

The electrodeposition coating material of the composition includes component (a) preferably in an amount in a range of from 15 to 85 wt.-%, more preferably of from 20 to 80 wt.-%, very preferably of from 25 to 77.5 wt.-%, more particularly of from 30 to 75 wt.-% or of from 35 to 75 wt.-%, most preferably of from 40 to 70 wt.-% or of from 45 to 70 wt.-% or of from 50 to 70 wt.-%, based in each case on the total solids content of the electrodeposition coating composition. Alternatively, the electrodeposition coating material composition of the invention includes component (a) preferably in an amount in a range of from 1 to 80 wt.-%, more preferably of from 2.5 to 75 wt.-%, very preferably of from 5 to 70 wt.-%, more particularly of from 7.5 to 65 wt.-%, most preferably of from 8 to 60 wt.-% or of from 10 to 50 wt.-%, based in each case on the total weight of the electrodeposition coating material composition respectively the coating bath.

The electrodeposition coating material composition of the invention additionally includes at least one crosslinking agent component (b), said component (b) is preferably present in an amount in the range of from 5 to 45 wt.-%, more preferably of from 6 to 42.5 wt.-%, very preferably of from 7 to 40 wt.-%, more particularly of from 8 to 37.5 wt.-% or of from 9 to 35 wt.-%, most preferably of from 10 to 35 wt.-%, especially preferably of from 15 to 35 wt.-%, based in each case on the total solids content of the electrodeposition coating composition. Alternatively, the electrodeposition coating composition of the invention includes at least one crosslinking agent component (b), said component (b) is preferably present in an amount in a range of from 0.5 to 30 wt.-%, more preferably of from 1 to 25 wt.-%, very preferably of from 1.5 to 20 wt.-%, more particularly of from 2 to 17.5 wt.-%, most preferably of from 2.5 to 15 wt.-%, especially preferably of from 3 to 10 wt.-%, based in each case on the total weight of the electrodeposition coating material composition, respectively the coating bath.

The fractions in wt.-% of all of the components (a), (b) and water included in the electrodeposition coating composition of the invention, and also of further components that may be present additionally, add up to 100 wt.-%, based on the total weight of the electrodeposition coating material composition.

The relative weight ratio of components (a) and (b) to one another in the electrodeposition coating material composition is preferably in a range of from 5:1 to 1.1:1, more preferably in a range of from 4.5:1 to 1.1:1, very preferably in a range of from 4:1 to 1.2:1, more particularly in a range of from 3:1 to 1.5:1.

The inventive composition comprises at least one, preferably exactly one, binder dispersion (I). As known to the person skilled in the art, electrodeposition coating compositions regularly contain such a binder dispersion, i.e. an aqueous dispersion comprising at least one polymer as binder. Also, the inventive composition contains at least one pigment paste (II). Again, as known by the skilled person in the art, electrodeposition coating compositions regularly contain such pigment pastes.

In the following, different essential and optional components of the inventive compositions are described. More details on the binder dispersions (I) and pigment pastes (II) will also follow further below.

### Component (a)

Component (a) is at least one cathodically depositable polymer, which preferably functions as at least one binder in the inventive electrodeposition coating material composition. Simultaneously, component (a) may also function as grinding resin as it will be outlined hereinafter in more detail.

Any polymer is suitable as binder and thus as component (a) as long as it is cathodically depositable. Preferred are poly(meth)acrylates, (meth)acrylate copolymers, and epoxide polymers.

Preferably, component (a) of the electrodeposition coating composition of the invention comprises and/or is at least one epoxide-amine adduct.

An epoxide-amine adduct for the purposes of the present invention is a reaction product of at least one epoxy resin and at least one amine. Epoxy-amine adducts are hydroxyl functional, meaning that component (a) preferably is hydroxyl functional. Epoxy resins used are more particularly those based on bisphenol A and/or derivatives thereof. Amines reacted with the epoxy resins are primary and/or secondary amines or salts thereof and/or salts of tertiary amines.

The at least one epoxide-amine adduct used as component (a) is preferably a cationic, epoxide-based and amine-modified resin. The preparation of such cationic, amine-modified, epoxide-based resins is known and is described for example in DE 35 18 732, DE 35 18 770, EP 0 004 090, EP 0 012 463, EP 0 961 797 B1, and EP 0 505 445 B1. Cationic, epoxide-based, amine-modified resins are understood preferably to be reaction products of at least one polyepoxide having preferably two or more, e.g., three, epoxide groups, and at least one amine, preferably at least one primary and/or secondary amine. Particularly preferred polyepoxides are polyglycidyl ethers of polyphenols that are prepared from polyphenols and epihalohydrins. Polyphenols used may in particular be bisphenol A and/or bisphenol F. Other suitable polyepoxides are polyglycidyl ethers of polyhydric alcohols, such as, for example, of ethylene glycol, diethylene glycol, triethylene glycol, propylene 1,2-glycol, propylene 1,4-glycol, 1,5-pentanediol, 1,2,6-hexanetriol, glycerol, and 2,2-bis(4-hydroxycyclohexyl) propane. The polyepoxide used may also be a modified polyepoxide. Modified polyepoxides are understood to be those polyepoxides in which some of the reactive functional groups have been reacted with at least one modifying compound. Examples of such modifying compounds are as follows:
i) compounds containing carboxyl groups, such as saturated or unsaturated monocarboxylic acids (e.g., benzoic acid, linseed oil fatty acid, 2-ethylhexanoic acid, Versatic acid), aliphatic, cycloaliphatic and/or aromatic dicarboxylic acids of various chain lengths (e.g., adipic acid, sebacic acid, isophthalic acid, or dimeric fatty acids), hydroxyalkyl carboxylic acids (e.g., lactic acid, dimethylolpropionic acid), and carboxyl-containing polyesters, or
ii) compounds containing amino groups, such as diethylamine or ethylhexylamine or diamines with secondary amino groups, e.g., N,N′-dialkylalkylenediamines, such as dimethylethylenediamine, N,N′-dialkyl-polyoxyalkyleneamines, such as N,N′-dimethylpolyoxypropylenediamine, cyanoalkylated alkylenediamines, such as bis-N,N′-cyanoethylethylenediamine, cyanalkylated polyoxyalkyleneamines, such as bis-N,N′-cyanoethylpolyoxypropylenediamine, polyaminoamides, such as, for example, Versamides, especially amino-terminated reaction products of diamines (e.g., hexamethylenediamine), polycarboxylic acids, especially dimer fatty acids and monocarboxylic acids, more particularly fatty acids, or the reaction product of one mole of diaminohexane with two moles of monoglycidyl ether or monoglycidyl ester, especially glycidyl esters of α-branched fatty acids, such as Versatic acid, or iii) compounds containing hydroxyl groups, such as neopentyl glycol, bisethoxylated neopentyl glycol, neopentyl glycol hydroxypivalate, dimethylhydantoin-N,N′-diethanol, hexane-1,6-diol, hexane-2,5-diol, 1,4-bis(hydroxymethyl)cyclohexane, 1,1-iso-propylidenebis(p-phenoxy)-2-propanol, trimethylolpropane, pentaerythritol or amino alcohols, such as triethanolamine, methyldiethanolamine, or hydroxyl-group-containing alkylketimines, such as aminomethylpropane-1,3-diol methylisobutylketimine or tris(hydroxymethyl)aminomethane cyclohexanoneketimine, and also polyglycol ethers, polyester polyols, polyether polyols, polycaprolactone polyols, polycaprolactam polyols of various functionalities and molecular weights, or iv) saturated or unsaturated fatty acid methyl esters, which are esterified with hydroxyl groups of the epoxy resins in the presence of sodium methoxide.

Examples of amines which can be used for preparing component (a) are mono- and dialkylamines, such as methylamine, ethylamine, propylamine, butylamine, dimethylamine, diethylamine, dipropylamine, methylbutylamine, alkanolamines, such as methylethanolamine or diethanolamine, dialkylaminoalkylamines, such as dimethylaminoethylamine, diethylaminopropylamine, or dimethylaminopropylamine, for example. The amines which can be used may also include other functional groups as well, provided they do not disrupt the reaction of the amine with the epoxide group of the optionally modified polyepoxide and also do not lead to gelling of the reaction mixture. Secondary amines are preferably used. The charges that are needed for dilution in water and for electrical deposition may be generated by protonation with water-soluble acids (e.g., boric acid, formic acid, acetic acid, lactic acid, alkylsulfonic acids (e.g. methanesulfonic acid)); preferably acetic acid and/or formic acid). A further way of introducing cationic groups into the optionally modified polyepoxide is to react epoxide groups of the polyepoxide with amine salts.

The epoxide-amine adduct which can be used as component (a) is preferably a reaction product of an epoxy resin based on bisphenol A and primary and/or secondary amines or salts thereof and/or the salt of a tertiary amine.

### Component (b)

At least one crosslinking agent is present in the electrodeposition coating material composition as component (b), which preferably is selected from the group consisting of blocked polyisocyanates, free polyisocyanates, amino resins, and mixtures thereof. Said component (b) is different from component (a).

The term “blocked polyisocyanates” is known to the skilled person. Blocked polyisocyanates which can be utilized are polyisocyanates having at least two isocyanate groups (diisocyanates in case of precisely two isocyanate groups), but preferably having more than two, such as, for example, 3 to 5 isocyanate groups, wherein the isocyanate groups have been reacted, so that the blocked polyisocyanate formed is stable in particular with respect to hydroxyl groups and amino groups such as primary and/or secondary amino groups at room temperature, i.e., at a temperature of 18 to 23° C., but at elevated temperatures, as for example at ≥80° C., ≥110° C., ≥130° C., ≥140° C., ≥150° C., ≥160° C., ≥170° C., or ≥180°, reacts with conversion and with formation of urethane and/or urea bonds, respectively.

In the preparation of the blocked polyisocyanates it is possible to use any desired organic polyisocyanates suitable for crosslinking. Isocyanates used preferably are (hetero) aliphatic, (hetero)cycloaliphatic, (hetero) aromatic or (hetero) aliphatic-(hetero) aromatic isocyanates. Preferred polyisocyanates are those containing 2 to 36, especially 6 to 15, carbon atoms. Preferred examples are ethylene 1,2-ethylene diisocyanate, tetramethylene 1,4-diisocyanate, hexamethylene 1,6-diisocyanate (HDI), 2,2,4- and (2,4,4)-tri-methylhexamethylene 1,6-diisocyanate (TMDI), diphenylmethane diisocyanate (MDI), 1,9-diisocyanato-5-methylnonane, 1,8-diisocyanato-2,4-dimethyloctane, dodecane 1,12-diisocyanate, ω,ω′-di-isocyanatodipropyl ether, cyclobutene 1,3-diisocyanate, cyclohexane 1,3- and 1,4-diisocyanate, 3-isocyanatomethyl-3,5,5-trimethylcyclohexyl isocyanate (isophorone diisocyanate, IPDI), 1,4-diisocyanatomethyl-2,3,5,6-tetramethyl-cyclohexane, decahydro-8-methyl (1,4-methanonaphthalen-2 (or 3),5-ylenedimethylene diisocyanate, hexahydro-4,7-methanoindan-1 (or 2),5 (or 6)-ylenedimethylene diisocyanate, hexahydro-4,7-methanoindan-1 (or 2),5 (or 6)-ylene diisocyanate, hexahydrotolylene 2,4- and/or 2,6-diisocyanate (H6-TDI), toluene 2,4- and/or 2,6-diisocyanate (TDI), perhydrodiphenylmethane 2,4′-diisocyanate, perhydrodiphenylmethane 4,4′-diisocyanate (H₁₂MDI), 4,4′-diisocyanato-3,3′,5,5′-tetramethyldicyclohexylmethane, 4,4′-diisocyanato-2,2′,3,3′,5,5′,6,6′-octamethyldicyclohexylmethane, ω,ω′-diisocyanato-1,4-diethylbenzene, 1,4-di-isocyanatomethyl-2,3,5,6-tetramethylbenzene, 2-methyl-1,5-diisocyanatopentane (MPDI), 2-ethyl-1,4-diisocyanatobutane, 1,10-diisocyanatodecane, 1,5-diiso-cyanatohexane, 1,3-diisocyanatomethylcyclohexane, 1,4-diisocyanatomethylcyclohexane, 2,5 (2,6)-bis(isocyanatomethyl) bicyclo[2.2.1]heptane (NBDI), and also any mixture of these compounds. Polyisocyanates of higher isocyanate functionality may also be used. Examples thereof are trimerized hexamethylene diisocyanate and trimerized isophorone diisocyanate, more particularly the corresponding isocyanurates. It is also possible, furthermore, to utilize mixtures of polyisocyanates.

For the blocking of the polyisocyanates it is possible with preference to use any desired suitable aliphatic, cycloaliphatic, or aromatic alkyl monoalcohols. Examples thereof are aliphatic alcohols, such as methyl, ethyl, chloroethyl, propyl, butyl, amyl, hexyl, heptyl, octyl, nonyl, 3,3,5-trimethylhexyl, decyl, and lauryl alcohol; cycloaliphatic alcohols, such as cyclopentanol and cyclohexanol; aromatic alkyl alcohols, such as phenylcarbinol and methylphenylcarbinol. Likewise, suitable diols such as ethanediol, 1,2-propanediol, 1,3-propanediol and/or polyols may also be used for blocking of the polyisocyanates. Other suitable blocking agents are hydroxylamines, such as ethanolamine, oximes, such as methyl ethyl ketone oxime, acetone oxime, and cyclohexanone oxime, and amines, such as dibutylamine and diisopropylamine.

Tris(alkoxycarbonylamino)-1,3,5-triazine (TACT) are likewise known to the skilled person. The use of tris(alkoxycarbonylamino)-1,3,5-triazines as crosslinking agents in coating material compositions is known. For example, DE 197 12 940 A1 describes the use of such crosslinking agents in basecoat materials. U.S. Pat. No. 5,084,541 describes the preparation of corresponding compounds which can be used as component (c). Such triazines are for the purposes of the present invention to be encompassed by the term “blocked polyisocyanates”.

Amino resins (aminoplast resins) are likewise known to the skilled person. Amino resins used are preferably melamine resins, more particularly melamine-formaldehyde resins, which are likewise known to the skilled person. Preference, however, is given to using no amino resins such as melamine-formaldehyde resins as crosslinking agents (b). The electrodeposition coating material composition of the invention therefore preferably comprises no amino resins such as melamine-formaldehyde resins.

The electrodeposition coating material composition of the invention is used preferably as a one-component (1K) coating composition. For this reason, the electrodeposition coating composition of the invention preferably contains no free polyisocyanates.

Most preferably, at least one component (b) of the inventive composition is selected from blocked polyisocyanates. Preferred blocked polyisocyanates have an NCO content of, for example, 200 to 300 g/eq, more preferably, 225 to 275 g/eq (whereby g/eq means gram of component per mol of NCO in the component).

The molar ratio of hydroxyl groups of component (a) and the NCO groups of component (b), preferably, is from 1.5 to 3.5, preferably from 2.0 to 3.0.

Pigments and/or Fillers (c)

The electrodeposition coating material composition of the invention comprise at least one pigment and/or at least one filler (c).

The term “pigment” is known to the skilled person, from DIN 55943 (date: October 2001), for example. A “pigment” in the sense of the present invention refers preferably to a component in powder or flake form which is substantially, preferably entirely, insoluble in the medium surrounding them, such as the electrodeposition coating material composition of the invention, for example. Pigments are preferably colorants and/or substances which can be used as pigment on account of their magnetic, electrical and/or electromagnetic properties. Pigments differ from “fillers” preferably in their refractive index, which for pigments is ≥1.7.

The term “filler” is known to the skilled person, from DIN 55943 (date: October 2001), for example. “Fillers” for the purposes of the present invention preferably are components, which are substantially, preferably entirely, insoluble in the application medium, such as the electrodeposition coating material composition of the invention, for example, and which are used in particular for increasing the volume. “Fillers” in the sense of the present invention preferably differ from “pigments” in their refractive index, which for fillers is <1.7.

Any customary pigment known to the skilled person may be used. Examples of suitable pigments are inorganic and organic coloring pigments. Examples of suitable inorganic coloring pigments are white pigments such as titanium dioxide, zinc white, zinc sulfide or lithopone; black pigments such as carbon black, iron manganese black or spinel black; chromatic pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spinel phases and corundum phases or chromium orange; or yellow iron oxide, nickel titanium yellow, chromium titanium yellow, cadmium sulfide, cadmium zinc sulfide, chromium yellow or bismuth vanadate. Further inorganic coloring pigments are silicon dioxide, aluminum oxide, aluminum oxide hydrate, especially boehmite, titanium dioxide, zirconium oxide, cerium oxide, and mixtures thereof. Examples of suitable organic coloring pigments are monoazo pigments, disazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments metal complex pigments, perinone pigments, perylene pigments, phthalocyanine pigments or aniline black.

Any customary filler known to the skilled person may be used. Examples of suitable fillers are kaolin, dolomite, calcite, chalk, calcium sulfate, barium sulfate, graphite, silicates such as magnesium silicates, especially corresponding phyllosilicates such as hectorite, bentonite, montmorillonite, talc and/or mica, silicas, especially fumed silicas, hydroxides such as aluminum hydroxide or magnesium hydroxide. As examples of kaolin, commercial products like ASP 200 (non-calcined kaolin, Fa. BASF) or KaMin 2000C (calcined kaolin, Fa. KaMin) may be mentioned (with a preference on ASP 200). Also, organic fillers such as textile fibers, cellulose fibers, polyethylene fibers or polymer powders may be applied. For further details, reference is made to Römpp Lexikon Lacke und Druckfarben, Georg Thieme Verlag, 1998, pages 250 ff., “Fillers”.

The pigment plus filler content, based on the total weight of the electrodeposition material coating composition of the invention, is preferably in the range of from 0.1 to 20.0 wt.-%, more preferably of from 0.1 to 15.0 wt.-%, very preferably of from 0.1 to 10.0 wt.-%, especially preferably of from 0.1 to 5.0 wt.-%, and more particularly of from 0.1 to 2.5 wt.-%.

The pigment and/or filler is incorporated in the form of a pigment paste (II) into the electrodeposition coating material composition. It is possible and preferred that one pigment paste (II) comprises both one or more pigments and/or fillers. Such pastes typically include at least one polymer used as grinding resin. Preferably, therefore, there is at least one such polymer used as grinding resin included in the electrodeposition coating composition of the invention. It is possible that the at least one polymer (a) used as binder in the electrodeposition coating material composition can also additionally function as grinding resin in the pigment paste (II). The grinding resin in question is preferably an epoxide-amine adduct, which as outlined above may correspond to and/or can be subsumed under the definition of component (a). The polymer used as grinding resin preferably has building blocks which interact with the surfaces of the pigments. The grinding resins therefore preferably have the effect of an emulsifier. In many cases quaternary ammonium compounds are incorporated for the purpose of improving the grinding resin properties. Besides the grinding resins, further customary additives like wetting agents or dispersants (optional components (d) as described below) and also solvents (water and organic co-solvents) may be comprised. The production of the pigment paste includes a grinding/milling step. Thereby, the pigments and/or fillers are preferably ground together with a grinding resin and the further components/solvents to form a pigment paste. To produce the finished electrodeposition coating material composition, this paste is mixed with the rest of the constituents, in particular the binder dispersion (I). The use of a pigment paste leads advantageously to a greater flexibility in electrodeposition coating, since the pigment/filler and binder of the electrodeposition coating material composition can be readily adapted at any time to the requirements of practice via the amount of the pigment paste.

As mentioned above, the inventive composition contains at least one binder dispersion (I). The binder dispersion (I) contains at least one component (a) and at least one component (b). Also, the binder dispersion (I) regularly contains further optional components (d) mentioned below. Besides water, also further organic co-solvents may be part of the binder dispersion (I).

### Further Optional Components

Depending on desired application, the electrodeposition coating material composition of the invention may comprise one or more commonly employed further additives as one or more optional components (d). Component (d) is different from any of components (a) to (c) and also from the below described composite particles (p). Preferably, these additives are selected from the group consisting of wetting agents, emulsifiers, dispersants, surface-active compounds such as surfactants, flow control assistants, solubilizers, defoamers, rheological assistants, antioxidants, stabilizers, preferably heat stabilizers, process stabilizers, and UV and/or light stabilizers, flexibilizers, plasticizers, and mixtures of the aforesaid additives. The additive content may vary very widely according to intended use. The additive content, based on the total weight of the electrodeposition material coating composition of the invention, is preferably in the range of from 0.1 to 20.0 wt.-%, more preferably of from 0.1 to 15.0 wt.-%, very preferably of from 0.1 to 10.0 wt.-%, especially preferably of from 0.1 to 5.0 wt.-%, and more particularly of from 0.1 to 2.5 wt.-%.

### Composite Particles (p)

The composition of the invention comprises as essential component at least one kind of composite particles (p). Preferably, exactly one kind of composite particles is comprised. The composite particles (p) comprise at least one metal-containing catalyst (pc), preferably exactly one metal-comprising catalyst (pc). Quite obviously, the metal-containing catalyst (pc) is a metal-containing catalyst for catalyzing chemical reaction of the cathodically depositable polymer (a) and the crosslinking agent component (b).

The metal-containing catalyst (pc) in particular is selected from a tin- or bismuth-containing catalyst. Even more preferably, the catalyst (pc) is a bismuth-containing catalyst, in particular a bismuth(III)-containing catalyst. With particular preference it is possible to use a bismuth-containing catalyst, such as, for example, bismuth(III) oxide, basic bismuth(III) oxide, bismuth(III) hydroxide, bismuth(III) carbonate, bismuth(III) nitrate, bismuth(III) subnitrate (basic bismuth(III) nitrate), bismuth(III) salicylate and/or bismuth(III) subsalicylate (basic bismuth(III) salicylate), bismuth(III) carboxylates like in particular bismuth(III) neodecanoate, and also mixtures thereof. Especially preferred are water-insoluble catalysts, preferably water-insoluble bismuth-containing catalysts. Preferred more particularly are bismuth(III) carboxylates, more preferably bismuth(III) neodecanoate.

The electrodeposition coating material composition of the invention preferably includes at least one bismuth(III)-containing catalyst in an amount such that the bismuth(III) content, calculated as bismuth metal, based on the total weight of the electrodeposition coating material of the invention, is in a range from 10 ppm to 20,000 ppm, preferably 100 to 15,000 ppm, more preferably 500 to 10,000 ppm and particularly preferred 1000 to 5000 ppm. The amount of bismuth, calculated as metal, may be determined by means of inductively coupled plasma-atomic emission spectrometry (ICP-OES) in accordance with DIN EN ISO 11885 (date: September 2009). Accordingly, the amount of composite particles (p) is preferably chosen as corresponding to the above specified amounts of bismuth, calculated as metal.

The composite particles (p) comprise at least one (meth)acrylate-based polymer (mp), preferably exactly one such polymer (mp).

(Meth)acrylate-based polymers, generally speaking, are known to the person skilled in the art. Such polymers comprise, in reacted form, acrylate-based and/or methacrylate-based monomers like, for example, (meth)acrylic acid and esters, nitriles, or amides of (meth)acrylic acid. Of course, (meth)acrylate-based polymers may also contain, in reacted form, further olefinically unsaturated monomers like vinylic olefinically unsaturated monomers, alpha-beta unsaturated carboxylic acids, and allyl compounds. Accordingly, while a significant part of monomers, i.e. more than 30% by weight or more than 50% by weight (in each case based on the total weight of monomers) will in any case be acrylate-based and/or methacrylate-based monomers, such polymers may also comprise the prementioned further olefinically unsaturated monomers. Such olefinically unsaturated monomers may be monoolefinically or polyolefinically unsaturated. Production of these polymers include, for example, radical polymerization of the mentioned olefinically unsaturated monomers.

The (meth)acrylate-based monoolefinically unsaturated monomers may be, for example, (meth)acrylic acid and esters, nitriles, or amides of (meth)acrylic acid.

Esters of (meth)acrylic acid are, in particular, those having a radical R which is not olefinically unsaturated.

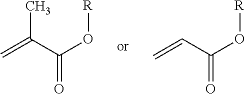

The radical R may be aliphatic or aromatic. The radical R is preferably aliphatic. The radical R may be, for example, an alkyl radical, or may contain heteroatoms. Examples of radicals R which contain heteroatoms are ethers. Preference is given to using at least, but not necessarily exclusively, monomers in which the radical R is an alkyl radical.

If R is an alkyl radical, it may be a linear, branched, or cyclic alkyl radical. In all three cases, the radicals in question may be unsubstituted or else substituted by functional groups. The alkyl radical preferably has 1 to 24, more preferably 1 to 10, carbon atoms.

Monounsaturated esters of (meth)acrylic acid with an unsubstituted alkyl radical that are suitable with particular preference are methyl (meth)acrylate, ethyl (meth)acrylate, propyl (meth)acrylate, isopropyl (meth)acrylate, n-butyl (meth)acrylate, isobutyl (meth)acrylate, tert-butyl (meth)acrylate, amyl (meth)acrylate, hexyl (meth)acrylate, ethylhexyl (meth)acrylate, propylheptyl (meth)acrylate, 3,3,5-trimethylhexyl (meth)acrylate, stearyl (meth)acrylate, lauryl (meth)acrylate, cycloalkyl (meth)acrylates, such as cyclopentyl (meth)acrylate, isobornyl (meth)acrylate, and also cyclohexyl (meth)acrylate, with n- and tert-butyl (meth)acrylate and methyl methacrylate being especially preferred.

Suitable monounsaturated esters of (meth)acrylic acid with a substituted alkyl radical may be substituted by one or more hydroxyl groups, phosphoric ester groups or amino groups like primary, secondary or tertiary amino groups.

Monounsaturated esters of (meth)acrylic acid with an alkyl radical substituted by one or more hydroxyl groups are 2-hydroxy-ethyl (meth)acrylate, 2-hydroxypropyl (meth)acrylate, 3-hydroxypropyl (meth)acrylate, 3-hydroxybutyl (meth)acrylate and 4-hydroxybutyl (meth)acrylate, with 2-hydroxyethyl (meth)acrylate being especially preferred.

Monounsaturated esters of (meth)acrylic acid with phosphoric ester groups are, for example, the phosphoric ester of polypropylene glycol monomethacrylate, such as the commercially available Sipomer PAM 200 from Rhodia.

Monosaturated esters of (meth)acrylic acid with amino groups are, for example, dimethylaminoethyl (meth)acrylate, diethylaminoethyl (meth)acrylate, dimethylaminopropyl (meth)acrylate, diethylaminopropyl (meth)acrylate, 2-(tert-butylamino)ethyl (meth)acrylate, 2-aminoethyl (meth)acrylate hydrochloride, 2-N-morpholinoethyl (meth)acrylate, 2-(diisopropylamino)ethyl (meth)acrylate or 3-(diisopropylamino) propyl (meth)acrylate.

Amides of (meth)acrylic acid are those known to the person skilled in the art, for example (meth)acrylamide, N,N-dimethyl (meth)acrylamide, N,N-diethyl (meth)acrylamide, N-propyl (meth)acrylamide, N-isopropyl (meth)acrylamide, N-butyl (meth)acrylamide, N-tert-butyl (meth)acrylamide, N-ethyl (meth)acrylamide, N-propyl (meth)acrylamide, N-butyl (meth)acrylamide, N-phenyl (meth)acrylamide, N-(1-naphthyl)-N-phenyl (meth)acrylamide, N-(triphenylmethyl) methacrylamide N-[3-(dimethylamino)-propyl]-(meth)acrylamide, N-[3-(diethylamino)-propyl]-(meth)acrylamide, N-[2-(dimethylamino)-ethyl]-(meth)acrylamide, N-[2-(diethylamino)-ethyl]-(meth)acrylamide, 4-(meth)acryloylmorpholine, N-(3-aminopropyl)-(meth)acrylamide hydrochloride, N-(2-aminoethyl)-(meth)acrylamide hydrochloride, diacetone (meth)acrylamide, N-(hydroxymethyl)-(meth)acrylamide, N-(hydroxyethyl)-(meth)acrylamide N-(isobutoxymethyl)(meth)acrylamide, N-(hydroxyethyl)-(meth)acrylamide, N-(3-methoxypropyl)(meth)acrylamide, 2-hydroxypropyl (meth)acrylamide, N-[tris(hydroxymethyl)methyl]acrylamide or N-methylol (meth)acrylamide.

Vinylic monounsaturated monomers may be monomers having a radical R′ on the vinyl group that is not olefinically unsaturated.

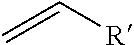

The radical R′ may be aliphatic or aromatic, with aromatic radicals being preferred.

The radical R′ may be a hydrocarbon radical or may contain heteroatoms. Examples of radicals R′ which contain heteroatoms are ethers, esters, amides, nitriles, and heterocycles. The radical R′ is preferably a hydrocarbon radical. Where R′ is a hydrocarbon radical, it may be unsubstituted or substituted by heteroatoms, with unsubstituted radicals being preferred. The radical R′ is preferably an aromatic hydrocarbon radical.

Preferred vinylic olefinically unsaturated monomers are vinylaromatic hydrocarbons, especially vinyltoluene, alpha-methylstyrene, and especially styrene.

If heteroatoms are included, olefinically unsaturated monomers are preferred, such as acrylonitrile, methacrylonitrile, acrylamide, methacrylamide, N, N-dimethylacrylamide, N-[3-(dimethylamino)-propyl]-methacrylamide, vinyl acetate, vinyl propionate, vinyl chloride, N-vinylpyrrolidone, N-vinylcaprolactam, N-vinylformamide, N-vinylimidazole, and N-vinyl-2-methylimidazoline.

Examples of suitable polyolefinically unsaturated monomers encompass esters of (meth)acrylic acid with an olefinically unsaturated radical R″, and allyl ethers of mono- or polyhydric alcohols. The radical R″ may be an allyl radical or a (meth)acryloyl radical.

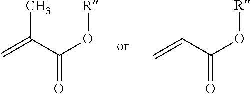

Preferred polyolefinically unsaturated monomers include ethylene glycol di(meth)acrylate, 1,2-propylene glycol di(meth)acrylate, 2,2-propylene glycol di(meth)acrylate, butane-1,4-diol di(meth)acrylate, neopentyl glycol di(meth)acrylate, 3-methylpentanediol di(meth)acrylate, diethylene glycol di(meth)acrylate, triethylene glycol di(meth)acrylate, tetraethylene glycol di(meth)acrylate, dipropylene glycol di(meth)acrylate, tripropylene glycol di(meth)acrylate, polyethylene glycol di(meth)acrylate, hexanediol di(meth)acrylate, and allyl (meth)acrylate.

Polyolefinically unsaturated compounds additionally include acrylic and methacrylic esters of alcohols having more than two OH groups, such as, for example, trimethylolpropane tri(meth)acrylate or glycerol tri(meth)acrylate, but also trimethylolpropane di(meth)acrylate monoallyl ether, trimethylolpropane (meth)acrylate-diallyl ether, pentaerythritol tri(meth)acrylate monoallyl ether, pentaerythritol di(meth)acrylate diallyl ether, pentaerythritol (meth)acrylate triallyl ether, triallylsucrose, and pentaallylsucrose.

Preferably, the (meth)acrylate-based polymer comprises a monomer mixture consisting of (a) 40 to 98% by weight, preferably 50 to 88% by weight, of C₁-C₁₀-alkyl esters of (meth)acrylic acid, (b) 2 to 45% by weight, preferably 5 to 30% by weight of polyolefinically unsaturated monomers, in particular diolefinically unsaturated monomers and (c) 0 to 20% by weight, preferably 2 to 10% by weight of monoolefinically unsaturated monomers which differ from monomers (a). The term “polymer composed of a monomer mixture consisting of” is equivalent to the term “applied for manufacture (i.e., polymerization) of the polymer”. Preferably, the (meth)acrylate-based polymer is composed of the beforementioned monomer mixture.

In a preferred embodiment, at least one monomer (c) is selected from monomers having at least one, preferably one amino group. With even more preference, monomers (c) are selected from at least one monomer having at least one amino group, preferably one amino group (i.e. monomers (c) are composed of only monomers having at least one, preferably one amino group). Reason is that such monomers may be protonated and thus transferred into a cationic state, meaning that the composite particles, within a cationic electrodeposition process, may be driven to the to-be-coated substrate in order to facilitate actual deposition (similar as occurring with above-described component (a)).

It is preferred that the (meth)acrylate-based polymer is prepared in the presence of the metal-containing catalyst. This in-situ production provides very well for formation of actual composite particles, i.e. particles being hybrids of both the (meth)acrylate-based polymer and the catalyst.

Accordingly, the principle of production of the composite particles is preferably based on production from the above-specified monomers and the catalyst together with preferably a free-radical initiator in a reaction medium for polymerizing the monomers. Preferably, production takes place in an oil-in-water emulsion in which the monomers and the preferably water-insoluble catalyst plus potentially an organic solvent for solubilizing the catalyst (for example n-butyl acetate) take the form of the disperse phase in the aqueous dispersion medium, whereby preferably dispersants are included to enhance the formation of the dispersive character and to avoid aggregation and coagulation of the formed particles. In a preferred embodiment it is possible to delay addition of the free-radical initiator until after the dispersion process. The polymerization of the monomers is then induced via, for example, heating, and is optionally controlled via further temperature increase, whereupon the resultant polymer and catalyst form the composite particles. Of course, the polymerization could also be induced by other known means, for example redox initiators or UV radiation. However, temperature increase is preferred. In the end, in this embodiment the composite particles will be available in form of an aqueous dispersion (or emulsion), i.e. in form of particles being present in an aqueous medium. It is preferred that the composite particles (p) are present, after production, in form of an aqueous dispersion as this allows direct application within the inventive electrocoat material.

As mentioned above, production of the particles preferably take place in the presence of at least one dispersant. Accordingly, the aqueous phase usually contains at least one dispersant in order to stabilize the droplets of the o/w emulsion during its production. Dispersants suitable for stabilizing oil/water emulsions are common knowledge and are mentioned for example in EP 2794085 and EP 3007815 (therein also named protective colloids), the teaching of which is expressly incorporated by reference. Typical dispersants include polysaccharides, polyvinyl alcohols, polymers bearing sulfonate groups, polymers bearing carboxylate groups, polyvinylpyrolidone, copolymers of vinylpyrrolidone and inorganic pickering stabilizers. Suitable dispersants are typically water-soluble organic polymers. Inorganic pickering systems, such as colloidal silica and colloidal clay minerals may also be used as dispersants for this purpose. The pickering stabilizers, also referred to as pickering systems, may be used as such or in combination with the water-soluble organic polymers. Dispersants of the group of polysaccharides include, for example, cellulose derivatives such as hydroxyethyl cellulose, methyl hydroxyethyl cellulose, methyl cellulose and carboxymethyl cellulose, methyl hydroxypropyl cellulose, lignin sulfonates and also mixtures of the above.

Amongst the organic water-soluble polymers, particular preference is given to partially hydrolysed polyvinyl acetates, also termed partially hydrolysed polyvinyl alcohols (PVAs) with particularly having a degree of hydrolysis of 70% to 99.9%, in particular 75 to 99%, more particular 80 to 95%. In addition, PVA copolymers, as described in WO 2015/165836, are also suitable. The PVA may be in particular a carboxy-modified anionic PVA. Such a carboxy-modified PVA preferably has a proportion of carboxyl groups of 1 to 6 mol %. In particular, a carboxy-modified PVA is used as a dispersant, whose 4% by weight aqueous solution preferably has a viscosity in the range of 20.0 to 30.0 mPa*s at 20° C. Amongst the group of partially hydrolysed polyvinyl alcohols particular preference is given to those having a degree of hydrolysis of 70% to 99.9%, in particular 75 to 99%, more particular 80 to 95% and especially 85 to 95%. An especially preferred dispersant is a carboxy modified anionic PVA having 1 to 6 mol-% of carboxyl groups, based on the amount of repeating units and a degree of hydrolysis of in the range of 75 to 99%, in particular 80 to 95% and especially 85% to 95%. Amongst these, those are preferred, whose 4% by weight aqueous solution has a viscosity of 20.0 to 30.0 mPa*s at 20° C.

Also preferred dispersants are salts polymers bearing sulfonate groups. Such polymers include homo and copolymers of ethylenically unsaturated sulfonic acids, such as 2-acrylamide-2-methylpropane sulfonic acid, optionally with one or more water-soluble monomers, such as acrylamide or methacrylamide and the salts thereof. They also include the salts of lignin based sulfonic acids, also termed lignin sulfonates or lignosulfonates. Suitable lignin sulfonates may comprise, for example, sodium lignosulfonate, calcium lignosulfonate, ammonium lignosulfonate, magnesium lignosulfonate, potassium lignosulfonate, or sulfomethylated lignosulfonate. The aforementioned salts are in particular the sodium salts or the ammonium salts of the polymers bearing sulfonate groups.

Amongst the organic water-soluble polymers, preference is also given to polymers bearing carboxyl groups. Typically, such polymers are homo- or copolymers of monoethylenically unsaturated carboxylic acids, such as acrylic acid, methacrylic acid, maleic acid, fumaric acid or itaconic acid. The polymers bearing carboxyl groups are typically used in their partially or completely neutralized form, where the carboxyl groups are converted in the anionic carboxylate form. Typically the counterions are selected from sodium and ammonium.

The general production process for such composite particles in general is described by way of example in for example DE-A-10 139 171, and application WO 2011/004006, US 2015/361227 A1 and WO 2012/110443, expressly incorporated herein by way of reference.

Without wanting to be bound to a certain theory, the above-described production method conducted in oil-in-water emulsion is expected to facilitate the formation of capsules, i.e. particles having a shell or wall essentially comprising the resulting (meth)acrylate-based polymer (mp) enclosing the preferably water-insoluble catalyst (pc) which furthermore preferably is solubilized in an organic solvent.

The composite particles preferably have particle sizes (d₅₀(volume-based) measured by laser diffraction) in the range from 0.2 to 10 μm, preferably from 0.5 to 5 μm, in particular from 0.5 to 3 μm (d₅₀). Quite obviously, the given particle sizes relate to the particle sizes as measured in the form in which the particles are present after manufacture, i.e. therefore preferably in form of an aqueous dispersion (or emulsion).

The weight ratio (w/w) of the metal-containing catalyst to the (meth)acrylate-based polymer preferably is from 98:2 to 20:80, more preferably from 97:3 to 50:50 and most preferably 95:5 to 60:40. Calculation of the weight ratio is done by consideration of the overall weight of monomers applied for production of the polymer and the weight of applied metal catalyst. Also, preferably, the weight ratio (w/w) of metal in the metal containing catalyst (i.e. calculated as metal) to the (meth)acrylate-based polymer is from 90:10 to 5:95, more preferably 85:15 to 15:85 and most preferably 80:20 to 20:80.

The composite particles (p) may be introduced into the inventive composition by versatile means. For example, the composite particles (and the aqueous dispersion (emulsion) of the particles, respectively), may be applied as is in the production of the composition as individual recipe constituent. Also, the particles (and aqueous dispersion (emulsion) of the particles, respectively) may be part of, for example, the binder dispersion (I).

In line with the above, the present invention also relates to a method of production of composite particles (p) comprising at least one metal-containing catalyst (pc) and at least one (meth)acrylate polymer (mp), wherein the polymer (mp) is prepared in the presence of the metal-containing catalyst (pc), whereby the method comprises the steps of
(1) preparing an oil-in-water emulsion in which monomers for production of the polymer (mp) and the metal-containing catalyst are part of or are the disperse phase in an aqueous medium,
(2) polymerizing the monomers in the oil-in-water emulsion of step (1) by means of an initiator.

Preferably, the oil-in-water emulsion of step (1) comprises at least one protective colloid.

Also, the present invention relates to composite particles (p) prepared according to the above-defined method.

The present invention also relates to a method of manufacturing a cathodically depositable electrodeposition coating material composition comprising
provision of (I) at least one binder dispersion comprising at least one cathodically depositable polymer (a) and at least one crosslinking agent (b)
provision of at least one pigment paste (II) comprising at least one pigment and/or filler and at least one grinding resin,
optionally provision of further components being different from components (I) and (II),
mixing the binder dispersion (I), the pigment paste (II) and any further potential components of the composition,
   wherein at least one component comprises at least one kind of composite particles (p) comprising at least one metal-containing catalyst (pc) and at least one (meth)acrylate-based polymer (mp), wherein the polymer (mp) is prepared in the presence of the metal-containing catalyst (pc).

Quite obviously, any and all essential and also preferred features and embodiments mentioned above in the context of the inventive composition likewise apply for the kit of parts and method of manufacturing.

### Method for Electrocoating

A further subject of the present invention is a method for at least partially coating an electrically conductive substrate by cathodic electrodeposition coating comprising at least steps (1) to (5), namely
(1) immersing of the electrically conductive substrate at least partially into an electrodeposition coating bath, which comprises the inventive electrodeposition coating material composition,
(2) connecting the substrate as cathode,
(3) depositing a coating film obtained from the electrodeposition coating material composition on the substrate using direct current,
(4) removing the coated substrate from the electrodeposition coating bath, and
(5) baking the coating film deposited on the substrate.

All preferred embodiments described hereinabove in connection with the electrodeposition coating material composition of the invention are also preferred embodiments with regard to the aforesaid method of the invention using this electrodeposition coating material composition for at least partially coating an electrically conductive substrate by cathodic electrodeposition coating.

Preferably, the above-mentioned method comprises, between step (4) and (5), a step (4.1) of rinsing the coated substrate, for example with DI water. This step, quite obviously, serves the cleaning of the substrate, i.e. removal of residual coating material not being well deposited on the substrate.

The method of the invention is particularly suitable for the electrodeposition coating of automotive vehicle bodies or parts thereof including respective metallic substrates. Consequently, the preferred substrates are automotive vehicle bodies or parts thereof. Such substrates, in particular, are metallic automotive component parts like, for example, transverse control arms, spring-loaded control arms or dampers. Such component parts may be cast iron parts or may also be produced by other established methods known in the art. Further such substrates are metallic automotive bodies, for example automotive bodies that were partly stamped to cut out specific parts or form specific geometries and thus also comprise comparably many edges.

Suitability as electrically conductive substrate used in accordance with the invention are all electrically conductive substrates used customarily and known to the skilled person. The electrically conductive substrates used in accordance with the invention are preferably metallic substrates, more preferably selected from the group consisting of steel, preferably steel selected from the group consisting of bare steel, cold rolled steel (CRS), hot rolled steel, galvanized steel such as hot dip galvanized steel (HDG), alloy galvanized steel (such as, for example, Galvalume, Galvannealed or Galfan) and aluminized steel, aluminum and magnesium, and also Zn/Mg alloys and Zn/Ni alloys. Particularly suitable substrates are parts of vehicle bodies or complete bodies of automobiles for production.

Before the respective electrically conductive substrate is used in step (1) of the inventive method, it is preferably cleaned and/or degreased.

The electrically conductive substrate used in accordance with the invention is preferably a pretreated substrate, for example pretreated with at least one metal phosphate such as zinc phosphate. A pretreatment of this kind by means of phosphating, which takes place normally after the substrate has been cleaned and before the substrate is electrodeposition-coated in step (1), is in particular a pretreatment step that is customary in the automobile industry. Pretreatment methods other than phosphating are, however, also possible, for example a thin film pretreatment based on zirconium oxide or typical silanes.

During performance of steps (1), (2), and (3) of the method of the invention, the electrodeposition coating material composition of the invention is deposited cathodically on the region of the substrate immersed into the bath in step (1). In step (2), the substrate is connected as the cathode, and an electrical voltage is applied between the substrate and at least one counterelectrode, which is located in the deposition bath or is present separately from it, for example by way of an anion exchange membrane which is permeable for anions. The counterelectrode functions, accordingly, as an anode. On passage of electrical current between anode and cathode, a firmly adhering coating film is deposited on the cathode, i.e., on the immersed part of the substrate. The voltage applied here is preferably in a range from 50 to 500 volts. On performance of steps (1), (2), and (3) of the method of the invention, the electrodeposition coating bath preferably has a bath temperature in a range from 20 to 45° C.

The baking temperature in step (5) is preferably in a range from 100 to 210° C., more preferably from 120 to 205° C., very preferably from 120 to 200° C., more particularly from 125 to 195° C. or from 125° C. to 190° C., most preferably from 130 to 185° C. or from 140 to 180° C.

After having performed step (5) of the inventive method one or more further coating layers can be applied onto the baked coating film obtained after step (5). For example, a primer and/or filler can be applied, followed by a basecoat and a clearcoat.

Therefore, the inventive method preferably comprises at least one further step (6), namely
(6) applying at least one further coating material composition, which is different from the composition applied in step (1), at least partially onto the baked coating film obtained after step (5).

### Substrate

A further subject of the present invention is an electrically conductive substrate which is coated at least partially with a baked electrodeposition coating material of the invention. The baked coating material corresponds to the baked coating film obtained after step (5) of the inventive method.

All preferred embodiments described hereinabove in connection with the electrodeposition coating material composition of the invention and the method of the invention are also preferred embodiments with regard to the aforesaid at least partially coated substrate of the invention.

Of course, also a baked electrodeposition coating layer produced from an inventive electrodeposition coating material composition is a subject of the present invention.

### Use

A further subject of the present invention is the use of the composite particles (p) for increasing the robustness of an electrodeposition coating bath against phosphate contamination.

### Methods

### 1. Determining the Non-Volatile Fraction

The nonvolatile fraction (the solids or solids content) is determined in accordance with DIN EN ISO 3251 (date: June 2019). This involves weighing out 1 g of sample into an aluminum dish which has been dried beforehand and drying the dish with sample in a drying cabinet at 180° C. for 30 minutes, cooling it in a desiccator, and then reweighing. The residue, relative to the total amount of sample employed, corresponds to the nonvolatile fraction (in % or wt.-%)

### 2. Determination of Glass Transition Temperature T_{g}

The glass transition temperature T_{g} is determined with differential scanning calorimetry (DSC) according to DIN 53765:1994-03 using a heating rate of 10 K/min.

### 3. Determination of pH Value

The pH value was determined according to DIN 55659-1 (January 2012).

### 4. Determination of Dry Film Thicknesses

The film thicknesses are determined according to DIN EN ISO 2808 (date: May 2007), method 12A, using Dualscope FM40 instrument from Fischer.

### 5. Determination of Acetone Resistance

The determination of the acetone resistance is performed on test panels (GB 6800/OC Chemetall) that were ED-coated and cured according to the above mentioned 5 step procedure. The coated panels are rubbed with a hammer-like tool which has a weight of 1 kg and a head containing a cotton wool immersed in acetone. The hammer-like tool and with it the wool with acetone is pushed and pulled over the coating surface without any additional pressure, one time in each direction is counted as 1 double rub. 200 double rubs are evaluated as excellent acetone resistance, meaning that 200 double rubs are the maximum number of double rubs conducted in the test. The number of double rubs given below in the result section corresponds to the number at which a delamination of cured coating material is observed (or, in case of a result of 200 in acetone resistance, no such delamination occurs).

### 6. Average Particle Size Diameter

Particle size distribution of the composite particles is measured by laser diffraction according to ISO 13320 EN: 2020-01. Use was made of an Malvern Mastersizer 2000. The data were treated according to the Mie-Theory by software using a “universal model” provided by Malvern Instruments. Generally important parameters are the dₙ-values, for example with n=10, 50 and 90, i.e. the d₁₀, d₅₀ and doo values. The d₅₀ value, for example, is the volume-based average median d₅₀ particle size diameter.

### EXAMPLES

The following examples further illustrate the invention but are not to be construed as limiting its scope.

### 1. Preparation of Composite Particles (p) to be Applied According to the Invention

In the following, a general production protocol is described, before explicit production examples of two selected individual composite particles follow. Finally, an overall list of composite particles produced in accordance with the general production protocol is provided.

### 1.1 General Production Protocol

Water and an aqueous solution of a commercially available polyvinyl alcohol (10 wt.-%) were mixed to give a mixture 1. Separately, a mixture 2 of Bismuth neodecanoate catalyst, optionally an organic solvent, and the monomer(s) to be used for preparing the (meth)acrylate-based polymer was prepared. Mixture 2 was then emulsified in mixture 1 using, for example, a silent crusher (rotor stator dispersion tool) for 5 min at 18.000 rpm to result in an oil-in-water emulsion. Temperature was maintained below 35° C. during the emulsification step using an ice bath. The emulsion was then transferred to a glass reactor equipped with an anchor stirrer and a water-condenser and stirred at 130 rpm. Nitrogen gas was flown in the reactor over the whole polymerization. Radical initiator (thermal initiator) was then added to the media and the temperature was raised: Starting from 20° C., 75° C. is reached over 60 minutes (linear rate). Then, the temperature was raised to 85° C. within 60 min (linear rate) and held for 60 min. Afterwards, the system was cooled down to room temperature (20° C.) over 60 min (linear rate). At the beginning of the cooling, initiators (redox initiator partners) were added over 50 minutes to the media to decrease the residual monomer content.

Monomers applied were as follows: MMA: methyl methacrylate, tBMA: tert-butyl methacrylate, DMAPMA: Dimethylaminopropyl methacrylamide, nBA: n-butyl acrylate, BDDA: 1,4-butanediol diacrylate. As optional organic solvent, n-butyl acetate (BA) was applied. Vit C (L(+)-ascorbic acid) and tBHP (tert-Butylhydroperoxide) were applied as redox initiator partner system.

### 1.2a) Example 1: MMA/tBMA/DMAPMA/BDDA=60/25/5/10—K-Kat XK 651/BA=75/25

Composite particles were prepared from (i) MMA/tBMA/DMAPMA/BDDA utilized in a 60/25/5/10 wt.-% ratio and (ii) 75/25 wt.-%-mixture of K-Kat XK 651 (King Industries) as active catalyst and BA as solvent. The targeted ratio of metal-containing catalyst and polymer was 90/10 wt.-%. An overall active content of 32.15 wt % in the final dispersion was targeted.

First, an aqueous solution was prepared by diluting 270.0 g of 10 wt.-% aqueous solution of Mowiol 40-88 in 271.64 g of demineralized water and 2.16 g of 2.5 wt.-% aqueous solution of sodium nitrite. Then, the oil phase was obtained by mixing 364.5 g of K-Kat XK 651, 121.5 g of BA, 32.4 g of MMA, 13.5 g of tBMA, 2.7 g of DMAPMA and 5.4 g of BDDA. In a 2 L glass reactor, the oil phase was emulsified in the water phase using a laboratory dissolver equipped with a 5 cm diameter dissolver disk for 40 min at 3.500 rpm. Temperature of the emulsion was maintained below 35° C. during the emulsification step using an ice bath. The glass reactor was then equipped with an anchor stirrer and a water-condenser and stirred at 130 rpm. Nitrogen gas was flown in the reactor over the whole polymerization. 3.24 g of tert-butyl peroxyneodecanoate was added as thermal initiator to the dispersion and the temperature was raised: Starting from 20° C., 75° C. was reached over 60 minutes (linear rate). Then, the temperature was raised to 85° C. within 60 min (linear rate) and held for 60 min. Afterwards, the system was cooled down to room temperature (20° C.) within 60 min (linear rate). At the beginning of the cooling, 15.66 g of 10 wt.-% aqueous solution tBHP was added within 3 min while 30.94 g of 10 wt.-% aqueous solution Vit C was added consecutively over 50 minutes to the media to decrease the residual monomer content.

Overall, 1134 g of aqueous dispersion of monodisperse composite particles (d₅₀=1.5 μm, d₉₀=2.3 μm) was obtained.

### 1.2b) Example 2: MMA/DMAPMA/BDDA=80/5/15—K-Kat XK 651

Composite particles were prepared from (i) MMA/DMAPMA/BDDA utilized in an 80/5/15 wt.-% ratio and (ii) K-Kat XK 651 (King Industries) as active catalyst. The targeted ratio of metal-containing catalyst and polymer was 90/10 wt.-%. An overall active content of 35.75 wt % in the final dispersion was targeted.

First, an aqueous solution was prepared by diluting 405 g of 10 wt.-% aqueous solution of Mowiol 40-88 in 160.95 g of demineralized water and 4.32 g of 2.5 wt.-% aqueous solution of sodium nitrite. 0.03 g of Tego Foamex 3062 defoamer was added. Then, the oil phase was obtained by mixing 486 g of K-Kat XK 651, 43.2 g of MMA, 2.7 g of DMAPMA and 8.1 g of BDDA. In a 2 L glass reactor, the oil phase was emulsified in the water phase using a laboratory dissolver equipped with a 5 cm diameter dissolver disk for 40 min at 3.500 rpm. Temperature of the emulsion was maintained below 35° C. during the emulsification step using an ice bath. The glass reactor was then equipped with an anchor stirrer and a water-condenser and stirred at 130 rpm. 100 g demineralized water was added. Nitrogen gas was flown in the reactor over the whole polymerization. 3.24 g of tert-butyl peroxyneodecanoate was added as thermal initiator to the dispersion and the temperature was raised: Starting from 20° C., 75° C. was reached over 60 minutes (linear rate). Then, the temperature was raised to 85° C. within 60 min (linear rate) and held for 60 min. Afterwards, the system was cooled down to room temperature (20° C.) within 60 min (linear rate). At the beginning of the cooling, 30.94 g of 10 wt.-% aqueous solution Vit C was added within 3 min while 15.66 g of 10 wt.-% aqueous solution tBHP was added consecutively over 50 minutes to the media to decrease the residual monomer content. Finally, an additional 100 g of water was added when the temperature almost reached the 20° C.

Overall, 1360 g of aqueous dispersion of monodisperse composite particles (d₅₀=1.4 μm, d₉₀=2.2 μm) was obtained.

### 1.3 List of Composite Particles

Table 1 shows different composite particles prepared according to the general procedure outlined under 1.1.

TABLE 1

| | | Catalyst composition | Shell | d50 | d90 |
|---|---|---|---|---|---|
| | Polymer Composition (wt.-ratio) | (wt.-ratio) | % | (μm) | (μm) |
| Ex 1 | MMA/tBMA/DMAPMA/BDDA = 60/25/5/10 | K-Kat XK 651/BA = 75/25 | 10 | 1.5 | 2.3 |
| Ex 2 | MMA/DMAPMA/BDDA = 80/5/15 | K-Kat XK 651 = 100 | 10 | 1.4 | 2.2 |
| Ex 3 | MMA/tBMA/DMAPMA/BDDA = 60/25/5/10 | K-Kat XK 651/BA = 75/25 | 20 | 1.3 | 2.4 |
| Ex 4 | MMA/tBMA/DMAPMA/BDDA = 50/20/5/25 | K-Kat XK 651/BA = 75/25 | 10 | 1.3 | 2.2 |
| Ex 5 | MMA/tBMA/DMAPMA/BDDA = 40/15/5/40 | K-Kat XK 651/BA = 75/25 | 10 | 1.4 | 2.3 |
| Ex 6 | MMA/DMAPMA/BDDA = 55/5/40 | K-Kat XK 651/BA = 75/25 | 10 | 1.2 | 2.2 |
| Ex 7 | MMA/tBMA/DMAPMA/BDDA = 55/25/5/15 | K-Kat XK 651 = 100 | 10 | 1.6 | 3.0 |
| Ex 8 | MMA/DMAPMA/BDDA = 80/5/15 | K-Kat XK 651 = 100 | 10 | 1.6 | 2.5 |
| Ex 9 | MMA/DMAPMA/BDDA = 80/5/15 | K-Kat XK 651 = 100 | 10 | 1.5 | 2.4 |
| Ex 10 | MMA/tBMA/DMAPMA/BDDA = 60/25/5/10 | K-Kat XK 651/BA = 75/25 | 15 | 1.2 | 2.4 |
| Ex 11 | MMA/tBMA/DMAPMA/BDDA = 55/25/5/15 | DriCat 8320 = 100 | 10 | 1.4 | 2.3 |
| Ex 12 | MMA/DMAPMA/BDDA = 85/5/10 | DriCat 8320/BA = 75/25 | 10 | 1.5 | 3.0 |
| Ex 13 | MMA/tBMA/DMAPMA/BDDA = 60/25/5/10 | DriCat 8320/BA = 75/25 | 10 | 1.7 | 2.4 |
| Ex 14 | MMA/DMAPMA = 95/5 | K-Kat XK 651 = 100 | 20 | 1.0 | 1.7 |
| Ex 15 | MMA/BDDA = 85/15 | K-Kat XK 651 = 100 | 10 | 1.5 | 2.4 |
| Ex 16 | MMA/nBA/DMAPMA/BDDA = 40/40/5/15 | K-Kat XK 651 = 100 | 15 | 1.1 | 1.8 |
| Ex 17 | Sty/DMAPMA/BDDA = 80/5/15 | K-Kat XK 651 = 100 | 10 | 1.1 | 2.1 |

### 2. Preparation of Aqueous Cathodically Depositable Electrodeposition Coating Material Compositions

### 2.1 Pigment Pastes (II)

A standard pigment paste P1 customary used in the preparation of aqueous cathodically depositable electrodeposition coating material compositions was prepared by (i) mixing respective constituents in a dissolver and (ii) milling the mixture from (i) using a standard mill under customary conditions.

Pigment paste P1 comprises, as grinding resin, an aqueous dispersion of an epoxy-amine adduct (i.e. a resin fulfilling the requirements of component (a), solids content 40%, but being different from the component (a) described below for the binder dispersions (I)). Also, paste P1 comprises bismuth(III) subnitrate as a catalyst, carbon black as a black pigment and titanium dioxide as white pigment and also kaolin as a filler. As further constituents water and additives customary for aqueous cathodically depositable electrodeposition coating material compositions were applied. The solids content of pigment paste P1 is 65%. The amount of bismuth(III), calculated as bismuth metal, was 4.26%, based on the total weight of the pigment paste P1.

Pigment paste P2 was prepared the same way and with the same types and amounts of constituents as for pigment paste P1; however, with the exception that no bismuth(III) subnitrate was applied.

### 2.2 Binder Dispersions (I)

As standard binder dispersions (I), two systems customary applied in electrodeposition coating material compositions were used (binder dispersion (I).1 and binder dispersion (I).2). The binder dispersions contained an aqueous dispersion of an epoxy-amine adduct as binder resin (component (a)), a blocked polyisocyanate as crosslinking component (b) and also further constituents like, in particular, customary additives, organic co-solvents and water. The constituents of the binder dispersion were added in an individual order, whereby different mixing (dissolving) steps and dispersing stages took place. The two binder dispersions differ in terms of the crosslinker (b), i.e. the blocked polyisocyanate, more particular the type of blocking agents of the blocked polyisocyanates. Thereby, binder dispersion (I).2 possesses the higher reactivity (i.e. the lower deblocking temperature of the blocked polyisocyanate). The solids content of both binder dispersions is 38%.

### 2.3 Electrodeposition Coating Material Compositions

By means of the pigment pastes and binder dispersions above, electrodeposition coating material compositions were prepared. While the comparative systems were prepared from pigment paste P1 and the binder dispersions, the inventive compositions were prepared from pigment paste P2, binder dispersions and also composite particles according to Example 2 above.

Details on the respective baths and their constituents are shown in Table 2. The constituents listed in the Table have been mixed with each other in this order, whereby electrodeposition coating material compositions for application (item 2. below) were formed.

TABLE 2
Electrodeposition coating material compositions

| | Comparative | Inventive | Comparative | Inventive |
|---|---|---|---|---|
| | composition | Comp. 1 | composition | Comp. 1 |
| | (C1) | (E1) | (C2) | (E2) |
| Deionized water | 51.14 | 51.73 | 51.04 | 50.66 |
| Binder dispersion | 42.25 | 40.08 | | |
| (I).1 | | | | |
| Binder dispersion | | | 42.34 | 40.15 |
| (I).2 | | | | |
| Pigment Paste P1 | 6.11 | | 6.12 | |
| Pigment Paste P2 | | 4.76 | | 5.77 |
| Composite | | 2.93 | | 2.94 |
| particles (p) | | | | |
| (Ex. 2) | | | | |
| Edge Additive | 0.5 | 0.49 | 0.5 | 0.48 |
| Sum | 100 | 100 | 100 | 100 |
| pH of composition | 5.6 | 5.7 | 5.7 | 5.9 |
| Amount of | 2603 | 2119 | 2607 | 2365 |
| bismuth(III), | | | | |
| calculated as | | | | |
| bismuth metal | | | | |

### 3. Electrodeposition Coating of Substrates

Coating films obtained from the electrodeposition coating material compositions described above under Item 2.3 are deposited on cathodically connected test panels at a deposition voltage of between 200 and 260 V for (time of deposition varying accordingly to result in an overall electric charge of approximately 40-42 As) and a coating bath temperature of 32° C. and baked at a substrate temperature of 175° C. for 15 minutes afterwards, to obtain a coating layer thickness of approximately 20-22 Micrometer. Thereby, different amounts of phosphate were introduced into the baths before deposition, namely 0 ppm (control), 200 ppm and 400 ppm.

As test panels cold-rolled steel substrates which were pretreated with a phosphatizing composition (spray applied zinc manganese phosphatizing composition) were used (Gardobond® GB26S 6800 OC)).

Table 3 shows a list of all produced cured coatings.

TABLE 3

| | | Amount of |
|---|---|---|
| Cured | | phosphate |
| coating | Composition | [ppm] |
| A | C1 | 0 |
| B | C1 | 200 |
| C | C1 | 400 |
| D | E1 | 0 |
| E | E1 | 200 |
| F | E1 | 400 |
| G | C2 | 0 |
| H | C2 | 200 |
| I | C2 | 400 |
| J | E2 | 0 |
| K | E2 | 200 |
| L | E2 | 400 |

### 3. Investigation of the Properties of the Coated Substrates

According to the above-described methods, the glass transition temperature T_{g} and also acetone resistance of the cured coatings were investigated.

Tables 4 shows the respective data regarding corrosion testing.

TABLE 4

| | | Amount of | | |
|---|---|---|---|---|
| Cured | | phosphate | | Acetone |
| coating | Composition | [ppm] | Tg [°C] | resistance |
| A | C1 | 0 | 87 | 200 |
| B | C1 | 200 | 76 | 12 |
| C | C1 | 400 | 69 | 8 |
| D | E1 | 0 | 89 | 200 |
| E | E1 | 200 | 87 | 195 |
| F | E1 | 400 | 86 | 200 |
| G | C2 | 0 | 89 | 200 |
| H | C2 | 200 | 87 | 80 |
| I | C2 | 400 | 80 | 30 |
| J | E2 | 0 | 96 | 200 |
| K | E2 | 200 | 93 | 200 |
| L | E2 | 400 | 97 | 200 |

The results show, by means of high glass transition temperature as well as high acetone resistance that the inventive compositions and cured coatings, respectively, show significantly enhanced film formation and curing capabilities, respectively, at increasing phosphate poisoning. Specifically, while cured coatings B and C (and also H and I) show a significant drop in film formation and curing efficiency at phosphate levels of 200 ppm and 400 ppm, respectively, the inventive systems E and F (as well as K and L) still show optimal film formation behavior despite phosphate poisoning. Comparison of coatings B and C with H and I reflect the higher reactivity of binder dispersion (I).2 compared to dispersion (I). 1. However, this higher reactivity does not cope with the phosphate poisoning, as also systems H and I do not show sufficient film formation and crosslinking efficiency.

1. An aqueous cathodically depositable electrodeposition coating material composition comprising:
(I) at least one binder dispersion comprising at least one cathodically depositable polymer (a) and at least one crosslinking agent component (b); and
(II) at least one pigment paste containing at least one pigment and/or filler (c) and at least one polymer as grinding resin,
wherein the composition also comprises at least one kind of composite particles (p) comprising at least one metal-containing catalyst (pc) and at least one (meth)acrylate polymer (mp).

2. The aqueous cathodically depositable electrodeposition coating material composition according to claim 1, wherein at least one epoxide-amine adduct is present as at least one polymer (a).

3. The aqueous cathodically depositable electrodeposition coating material composition according to claim 1, wherein at least blocked polyisocyanate is present as at least one crosslinking agent (b).

4. The aqueous cathodically depositable electrodeposition coating material composition according to claim 1, wherein the metal-containing catalyst (pc) is a bismuth(III)-containing catalyst.

5. The aqueous cathodically depositable electrodeposition coating material composition according to claim 1, wherein the polymer (mp) comprises a monomer mixture consisting at least of (a) 40 to 98% by weight of C₁-C₁₀-alkyl esters of (meth)acrylic acid, (b) 2 to 45% by weight of polyolefinically unsaturated monomers and (c) 0 to 20% by weight of monoolefinically unsaturated monomers which differ from monomers (a).

6. The aqueous cathodically depositable electrodeposition coating material composition according to claim 1, wherein the polymer (mp) is prepared in the presence of the metal-containing catalyst (pc).

7. A method of production of composite particles (p) comprising at least one metal-containing catalyst (pc) and at least one (meth)acrylate polymer (mp), wherein the polymer (mp) is prepared in the presence of the metal-containing catalyst (pc), comprising the steps of
(1) preparing an oil-in-water emulsion in which monomers for production of the polymer (mp) and the metal-containing catalyst are part of or are the disperse phase in an aqueous medium, and
(2) polymerizing the monomers in the oil-in-water emulsion of step (1) by means of an initiator.

8. The method according to claim 7, wherein the oil-in-water emulsion of step (1) comprises at least one dispersant.

9. Composite particles (p) comprising at least one metal-containing catalyst (pc) and at least one (meth)acrylate polymer (mp) prepared by the method according to claim 7.

10. A method of manufacturing a cathodically depositable electrodeposition coating material composition comprising:
providing at least one binder dispersion (I) comprising at least one cathodically depositable polymer (a);
providing at least one pigment paste (II) comprising at least one pigment and/or filler; and
mixing the binder dispersion (I), the pigment paste (II) and any further potential components of the composition,
wherein at least one component of the composition comprises at least one kind of composite particles (p) comprising at least one metal-containing catalyst (pc) and at least one (meth)acrylate polymer (mp).

11. A method for at least partially coating an electrically conductive substrate by cathodic electrodeposition coating comprising at least steps (1) to (5),
(1) immersing the electrically conductive substrate at least partially into an electrodeposition coating bath, which comprises the electrodeposition coating material composition according to claim 1,
(2) connecting the substrate as cathode,
(3) depositing a coating film obtained from the electrodeposition coating material composition on the substrate using direct current,
(4) removing the coated substrate from the electrodeposition coating bath, and
(5) baking the coating film deposited on the substrate.

12. An electrically conductive substrate which is at least partially coated with the electrodeposition coating material composition according to claim 1.

13. A method of increasing the phosphate contamination resistance of an aqueous cathodically depositable electrodeposition coating material composition, the method comprising adding at least one kind of composite particles (p) comprising at least one metal-containing catalyst (pc) and at least one (meth)acrylate polymer (mp) to the electrodeposition coating material composition.

14. The method according to claim 13, wherein the polymer (mp) is prepared in the presence of the metal-containing catalyst (pc).

15. An electrically conductive substrate which is at least partially coated with the electrodeposition coating material composition manufactured according to claim 10 in baked form.

16. An electrically conductive substrate which is at least partially coated with the electrodeposition coating material composition obtained by the method according to claim 11.
